(19) United States
(12) Patent Application Publication
(10) Pub. No.: US 2026/0036984 A1
(43) Pub. Date: Feb. 5, 2026

(54) SEMANTIC LOCAL MAP GENERATION DEVICE AND METHOD

(71) Applicants: Hyundai Motor Company, Seoul (KR); Kia Corporation, Seoul (KR)

(72) Inventors: Yeongmin SONG, Hwaseong-Si (KR); Sunwoo Lee, Hwaseong-Si (KR); Jaeseon Kim, Hwaseong-Si (KR); Dongheon Shin, Hwaseong-Si (KR)

(73) Assignees: Hyundai Motor Company, Seoul (KR); Kia Corporation, Seoul (KR)

(21) Appl. No.: 18/946,344

(22) Filed: Nov. 13, 2024

(30) Foreign Application Priority Data
Aug. 5, 2024 (KR) 10-2024-0103755

(51) Int. Cl. G05D 1/246; G05D 111/10; G05D 111/50

(52) U.S. Cl. CPC G05D 1/2467; G05D 1/2465; G05D 2111/14; G05D 2111/52

(57) ABSTRACT

A semantic local map generation device may include a multi-sensor unit including a RGBD sensor and an inertial measurement unit (IMU) sensor attached to a body of a robot, and a data processing unit operatively connected to the multi-sensor unit and configured for estimating a pose of the robot and a semantic point cloud with respect to a driving region from sensor data obtained from the multi-sensor unit, and generate a semantic local map based on the estimated pose and the estimated semantic point cloud.

### CROSS-REFERENCE TO RELATED APPLICATION

The present application claims priority to Korean Patent Application No. 10-2024-0103755 filed on Aug. 5, 2024, the entire contents of which is incorporated herein for all purposes by this reference.

### BACKGROUND OF THE PRESENT DISCLOSURE

### Field of the Present Disclosure

The present disclosure relates to a semantic local map generation device and method. More particularly, the present disclosure relates to a semantic local map generation device and method configured for generating a semantic local map in real time for robot driving when no map has been obtained in advance.

### Description of Related art

When a driving robot drives, a map is necessary for the robot to drive autonomously. In contrast to the global map, the local map is a smaller, real-time observation map which may be processed using only the resources within the robot system.

In a mapless environment where there is no map for a robot to drive, the robot may first obtain in advance a map of the area where the robot plans to drive, which generates a workload in the robot system.

Conventionally, a separate high-performance server or control system for software processing was required to generate a local map, which resulted when a local map could not be generated depending on the driving environment.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a semantic local map generation device and method configured for enabling a robot to drive when a map has not been obtained by generating a semantic local map in real time while the robot is driving.

A semantic local map generation device may include a multi-sensor unit including a RGBD sensor and an inertial measurement unit (IMU) sensor attached to a body of a robot, and a data processing unit operatively connected to the multi-sensor unit and configured for estimating a pose of the robot and a semantic point cloud with respect to a driving region from sensor data obtained from the multi-sensor unit, and generate a semantic local map based on the estimated pose and the estimated semantic point cloud.

The multi-sensor unit may be configured to obtain the sensor data including a stereo infrared (IR) image, IMU data, RGB data, and depth data.

The data processing unit may be configured to transfer information on driveable and undriveable regions to the robot in a form of a set of 3-dimensional coordinates by use of the generated semantic local map.

The data processing unit may include a pose estimator configured for estimating the pose of the robot based on the stereo infrared image and the IMU data, a semantic cloud generator configured to generate the semantic point cloud based on the RGB data and the depth data, and a semantic local map generator configured to generate the semantic local map based on the pose and the semantic point cloud.

The pose estimator may be configured for estimating a position, a direction, and a speed of the robot by use of matching between visual feature points obtained from the continuous stereo infrared image and a pre-integration result of the IMU data.

The semantic cloud generator may be configured to generate a semantic image through the RGB data, and generate the semantic point cloud of a 3-dimensional (3D) coordinate system reference from a 2-dimensional (2D) image coordinate system of a sensor origin by use of the depth data and an intrinsic parameter of a camera.

The semantic cloud generator may be configured to determine a 2-dimensional semantic image from the RGB data, and determine a 3-dimensional semantic point cloud by combining the depth data and the 2-dimensional semantic image.

The semantic local map generator may be configured to generate the semantic local map in a 3-dimensional world coordinate system by multiplying the pose and a 3-dimensional semantic point cloud.

The RGBD sensor may be provided in a plurality, and the plurality of RGBD sensors may include a first sensor and a second sensor attached to a front surface of the body of the robot to be spaced apart from each other with a predetermined distance in a direction perpendicular to a ground surface, a third sensor and a fourth sensor attached to first and second side surfaces of the body, respectively, and a fifth sensor attached to a rear surface of the body.

The first sensor and the fifth sensor may be parallel to the ground surface, the second sensor is attached to be closer to the ground surface than the first sensor, and tilted in a direction toward the ground surface, and the third sensor and the fourth sensor may be tilted in the direction toward the ground surface, and rotated toward the front surface.

A semantic local map generation method may include obtaining sensor data for generating the semantic local map through multi-sensors including an RGBD sensor and an IMU sensor mounted on a body of a robot, and estimating a pose of the robot and a semantic point cloud (the semantic point cloud) from the sensor data, and generating the semantic local map in a 3-dimensional world coordinate system by use of the estimated pose and the semantic point cloud.

The obtaining of the sensor data may include obtaining a stereo infrared image from a visual sensor, IMU data from the IMU sensor, RGB data from the RGBD sensor, and depth data from the RGBD sensor.

The generating of the semantic local map may include transferring information on a driveable region and an undriveable region to the robot in a form of a set of 3-dimensional coordinates by use of the generated semantic local map.

The generating of the semantic local map may include estimating the pose of the robot based on the stereo infrared image and the IMU data, generating the semantic point cloud based on the RGB data and the depth data, and determining the semantic local map based on the pose and the semantic point cloud.

The estimating of the pose of the robot may include estimating a position, a direction, and a speed of the robot by use of matching between visual feature points obtained from the continuous stereo infrared image and pre-integration result of the IMU data.

The generating of the semantic point cloud may include generating a semantic image through the RGB data, and generating the semantic point cloud of a 3-dimensional (3D) coordinate system reference from a 2-dimensional (2D) image coordinate system of a sensor origin by use of the depth data and an intrinsic parameter of a camera.

The generating of the semantic point cloud may include determining a 2-dimensional semantic image from the RGB data, and determining a 3-dimensional semantic point cloud by combining the depth data and the 2-dimensional semantic image.

The determining the semantic local map may include generating the semantic local map in the 3-dimensional world coordinate system by multiplying the pose and the 3-dimensional semantic point cloud.

A field of view (FOV) of the RGB data may be smaller than a FOV of the depth data, and the generating of the semantic local map may include extracting a maximum FOV by combining depth data of a region outside the FOV of the RGB with the RGB data.

The semantic local map may display an obstacle, a driveable region, a person, and a undesignated region, in a manner to be distinguished from each other in the world coordinate system.

A semantic local map generation device and method according to various exemplary embodiments of the present disclosure may alleviate a workload to obtain a map in advance in a region where the robot is to drive by implementing a compact algorithm which may be operated in an embedded operating system built into the robot without employing a separate high-performance server or control system for software processing, and enable robot driving without being limited to indoor or outdoor environments by generating a local map including semantic information.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 shows a block diagram of a semantic local map generation device according to an exemplary embodiment of the present disclosure.

FIG. 2 is a block diagram for explaining the data processing unit of FIG. 1 according to an exemplary embodiment of the present disclosure.

FIG. 3 is a block diagram for explaining the semantic cloud generator of FIG. 2 according to an exemplary embodiment of the present disclosure.

FIG. 4 is a flowchart of a semantic local map generation method according to an exemplary embodiment of the present disclosure.

FIG. 5 is a drawing showing a semantic local map according to an exemplary embodiment of the present disclosure.

FIG. 6 is a drawing showing a robot according to an exemplary embodiment of the present disclosure.

FIG. 7 is a drawing showing a field of view (FOV) of a multi-sensor unit according to an exemplary embodiment of the present disclosure.

FIG. 8 is a drawing for explaining a computing device according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

An exemplary embodiment of the present disclosure will be described more fully hereinafter with reference to the accompanying drawings so that a person skill in the art may easily implement the embodiment. As those skilled in the art would realize, the described embodiments may be modified in various different ways, all without departing from the spirit or scope of the present disclosure. To clarify the present disclosure, portions that are not related to the description will be omitted, and the same elements or equivalents are referred to with the same reference numerals throughout the specification.

Furthermore, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

Furthermore, the terms “unit”, “part” or “portion”, “-er”, and “module” in the specification refer to a unit that processes at least one function or operation, which may be implemented by hardware, software, or a combination of hardware and software.

Hereinafter, various exemplary embodiments of the present disclosure will be described with reference to the drawings.

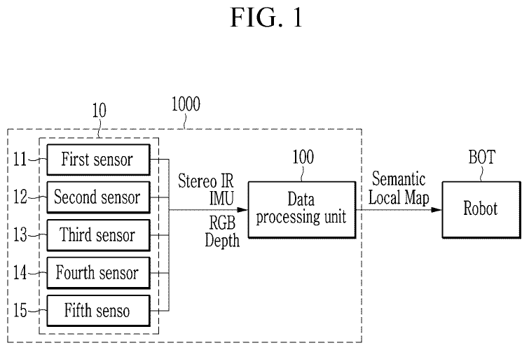

In FIG. 1, a robot BOT may include a driving robot and a hardware/software system for controlling the driving robot.

The driving robot may mean a robot configured for independently performing various operations including driving.

The hardware/software system for controlling the driving robot may be a system that organically combines hardware such as a sensor, an actuator, and a controller that play a key role in allowing the driving robot to operate autonomously and perform various tasks and software such as ROS, OpenCV, and TensorFlow.

The robot BOT may drive by use of a semantic local map generated from a semantic local map generation device 1000 even in the situation without a global map.

FIG. 1 shows a block diagram of the semantic local map generation device according to an exemplary embodiment of the present disclosure.

Referring to FIG. 1, the semantic local map generation device 1000 may include a multi-sensor unit 10 and a data processing unit 100.

The semantic local map generation device 1000 generates the semantic local map through the data processing unit 100 based on sensor data obtained from the multi-sensor unit 10, and may transfer the generated semantic local map to the robot BOT.

The semantic local map generation device 1000 may be implemented on a body of the driving robot. That is, a plurality of sensors of the multi-sensor unit 10 and the data processing unit 100 may be attached to the body of the robot.

The multi-sensor unit 10 may include an RGB-Depth (RGBD) sensor and an inertial measurement unit (IMU) sensor attached to the body of the robot.

That is, the multi-sensor unit 10 may be configured as a plurality of sensors including the RGBD sensor and the inertial measurement unit (IMU) sensor.

The multi-sensor unit 10 may include a plurality of RGBD sensors and at least one IMU sensor. Furthermore, the multi-sensor unit 10 may include a plurality of infrared cameras.

The multi-sensor unit 10 may obtain sensor data including a stereo infrared (IR) image, IMU data, RGB data, and depth data.

For example, the plurality of RGBD sensors may include a first sensor 11, a second sensor 12, a third sensor 13, a fourth sensor 14, and a fifth sensor 15.

First to fifth sensors 11, 12, 13, 14, and 15 may be attached to different positions on a body of the robot, respectively.

The data processing unit 100 may include an embedded HW/SW system for processing the sensor data.

The data processing unit 100 may estimate a pose of the robot BOT and a semantic point cloud with respect to a driving region from the sensor data obtained from the multi-sensor unit 10.

The data processing unit 100 may be configured to generate the semantic local map based on the estimated pose and the estimated semantic point cloud.

The data processing unit 100 may be configured to generate the semantic local map including 3-dimensional voxels (x, y, z, semantic class).

The data processing unit 100 may transfer information on driveable and undriveable regions to the robot BOT in a form of a set of 3-dimensional coordinates by use of the generated semantic local map.

That is, the data processing unit 100 may correspond to a slave with respect to a robot BOT configured as a master.

For example, the data processing unit 100 may transfer 3-dimensional (3D) point cloud information on obstacles and persons in a form of a set of 3D coordinates (x, y, z).

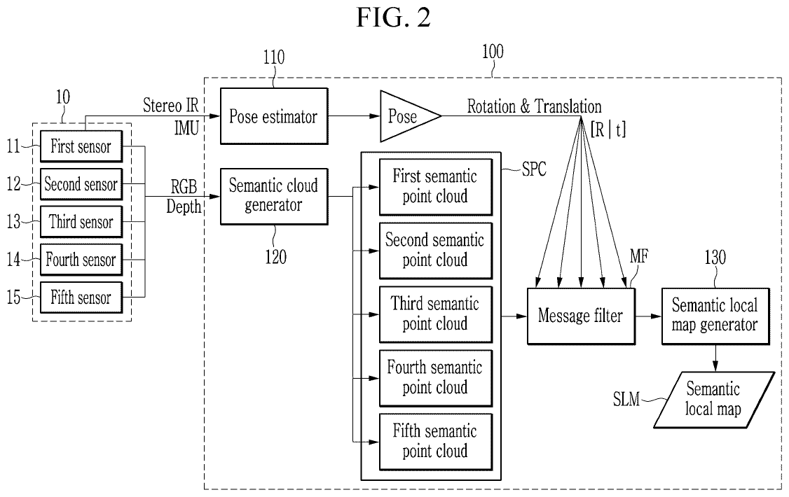

FIG. 2 is a block diagram for explaining the data processing unit of FIG. 1 according to an exemplary embodiment of the present disclosure.

The data processing unit 100 may include a pose estimator 110, a semantic cloud generator 120, and a semantic local map generator 130.

The pose estimator 110 may estimate the pose of the robot based on the stereo infrared image and the IMU data.

The pose estimator 110 may estimate the pose (i.e., rotation and translation) of the robot including an inclined degree and a moving distance of the robot by use of visual inertial odometry (VIO). The pose of the robot Rlt may be represented as a rotation matrix and a translation vector.

Visual inertial odometry (VIO) may be a method for estimating the pose of the robot by use of an image (visual data) and the IMU data of the IMU sensor.

That is, the pose estimator 110 may estimate a position, a direction, and a speed of the robot by use of matching between visual feature points obtained from the continuous stereo infrared image and a pre-integration result of the IMU data.

The semantic cloud generator 120 may be configured to generate a semantic point cloud (x, y, z, class) based on the RGB data and the depth data.

The semantic cloud generator 120 may estimate first to fifth semantic point clouds SPC with respect to respective sensors by use of the RGB data and the depth data obtained from the first to fifth sensors 11, 12, 13, 14, and 15.

The semantic local map generator 130 may be configured to generate a semantic local map SLM based on the pose and the semantic point cloud SPC.

The semantic local map generator 130 may be configured to generate the semantic local map SLM in a 3-dimensional world coordinate system by multiplying the pose and the 3-dimensional semantic point cloud SPC.

A message filter MF may filter messages by utilizing text analysis, machine-learning, context analysis, security technologies, or the like.

The semantic local map generator 130 may receive the pose and the semantic point cloud SPC filtered through the message filter MF, and generate the semantic local map SLM.

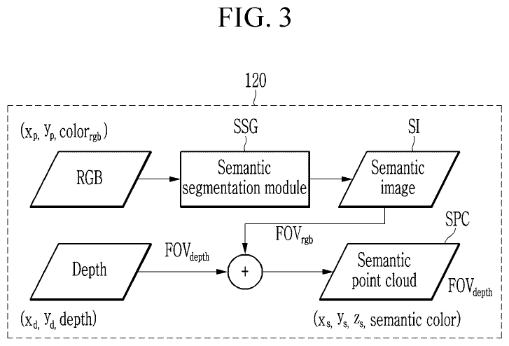

FIG. 3 is a block diagram for explaining the semantic cloud generator of FIG. 2 according to an exemplary embodiment of the present disclosure.

In FIG. 3, the semantic cloud generator 120 may be configured to determine a 2-dimensional semantic image SI from the RGB data through a semantic segmentation module SSG.

The semantic cloud generator 120 may be configured to determine the 3-dimensional semantic point cloud SPC by combining the depth data and the determined 2-dimensional semantic image.

The semantic cloud generator 120 may be configured to generate the semantic image through the RGB data, and generate the semantic point cloud of a 3-dimensional (3D) coordinate system reference from a 2-dimensional (2D) image coordinate system of a sensor origin by use of the depth data and an intrinsic parameter of the camera.

The intrinsic parameter of the camera may include a focal length, a principal point, and a skew coefficient.

The field of view (FOV) of the RGB data is smaller than the FOV of the depth data.

The semantic cloud generator 120 may perform an operation with respect to RGB FOV internal point ((xp, yp)) by use of Equation 1.

$$[ \begin{matrix}{x}_{s} \\ {y}_{s} \\ {z}_{s}\end{matrix} ] = [ \begin{matrix}{f}_{x} & {skew\_cf}_{x} & {c}_{x} \\ 0 & {f}_{y} & {c}_{y} \\ 0 & 0 & 1\end{matrix} ] [ \begin{matrix}{x}_{p} \\ {y}_{p} \\ d\end{matrix} ] \qquad [ Equation 1 ]$$

Here, (xs, ys, zs) is a 3-dimensional semantic cloud configuration point, (fx, fy) is a focal length, (cx, cy) is a principal point, skew_c is tan α, which is a skew coefficient, and (xp, yp) is an RGB-Depth FOV point inside 2-dimensional RGB FOV.

The semantic cloud generator 120 may perform an operation with respect to Depth FOV point (xd, yd) outside the RGB FOV by use of Equation 2.

$$[ \begin{matrix}{x}_{s} \\ {y}_{s} \\ {z}_{s}\end{matrix} ] = [ \begin{matrix}{f}_{x} & {skew\_cf}_{x} & {c}_{x} \\ 0 & {f}_{y} & {c}_{y} \\ 0 & 0 & 1\end{matrix} ] [ \begin{matrix}{x}_{d} \\ {y}_{d} \\ d\end{matrix} ] \qquad [ Equation 2 ]$$

Here, (xs, ys, zs) may be a semantic cloud configuration point on a sensor coordinate system, (fx, fy) is a focal length, (cx, cy) is a principal point, skew_c is tan a, which is a skew coefficient, and xd, yd is an Depth FOV point outside 2-dimensional RGB FOV.

That is, the semantic cloud generator 120 may convert semantic cloud configuration points (xs, ys, zs) on the sensor coordinate system into semantic map configuration points (xw, yw, zw) on the world coordinate system by use of Equation 3.

$$[ \begin{matrix}{x}_{w} \\ {y}_{w} \\ {z}_{w} \\ 1\end{matrix} ] = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ] [ \begin{matrix}{x}_{s} \\ {y}_{s} \\ {z}_{s} \\ 1\end{matrix} ] \qquad [ Equation 3 ]$$

Here, (xs, ys, zs) is a semantic cloud configuration point on a sensor coordinate system, (xw, yw, zw) is a semantic map configuration point on a world coordinate system, and r11 to r33 (3×3 rotation matrix) and t1 to t3 (3×1 translation vector) are the pose data [R|t] of the robot estimated by VIO.

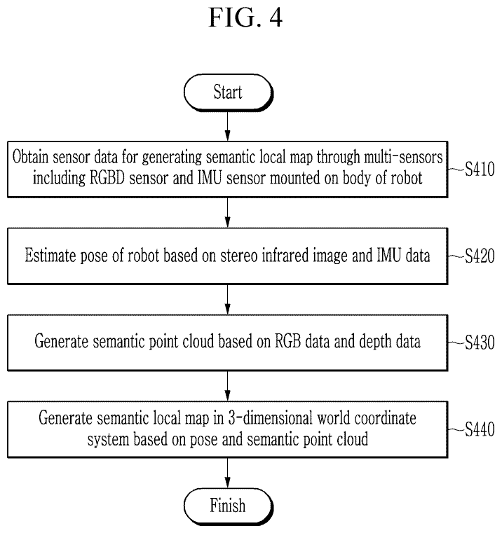

FIG. 4 is a flowchart of a semantic local map generation method according to an exemplary embodiment of the present disclosure. The semantic local map generation method of FIG. 4 may be performed through the semantic local map generation device 1000 of FIG. 1.

In FIG. 4, at step S410, the semantic local map generation device 1000 may obtain the sensor data for generating the semantic local map through multi-sensors including the RGBD sensor and the IMU sensor mounted on the body of the robot.

The semantic local map generation device 1000 may obtain the stereo infrared image from the visual sensor, the IMU data from the IMU sensor, the RGB data from the RGBD sensor, and the depth data from the RGBD sensor.

At step S420, the semantic local map generation device 1000 may estimate the pose of the robot based on the stereo infrared image and the IMU data.

The semantic local map generation device 1000 may estimate position, direction, and speed of the robot by use of matching between the visual feature points obtained from the continuous stereo infrared image and the pre-integration result of the IMU data.

At step S430, the semantic local map generation device 1000 may be configured to generate the semantic point cloud based on the RGB data and the depth data.

The semantic local map generation device 1000 may be configured to generate the semantic image through the RGB data, and generate the semantic point cloud of the 3-dimensional (3D) coordinate system reference from the 2-dimensional (2D) image coordinate system of the sensor origin by use of the depth data and the intrinsic parameter of the camera.

The semantic local map generation device 1000 may be configured to determine the 2-dimensional semantic image from the RGB data, and may be configured to determine the 3-dimensional semantic point cloud by combining the depth data and the 2-dimensional semantic image.

At step S440, the semantic local map generation device 1000 may be configured to generate the semantic local map in the 3-dimensional world coordinate system based on the pose and the semantic point cloud.

The semantic local map generation device 1000 may be configured to generate the semantic local map in the 3-dimensional world coordinate system by multiplying the pose and the 3-dimensional semantic point cloud (x, y, z).

The semantic local map generation device 1000 may transfer information on a driveable region and an undriveable region to the robot in a form of a set of 3-dimensional coordinates by use of the generated semantic local map.

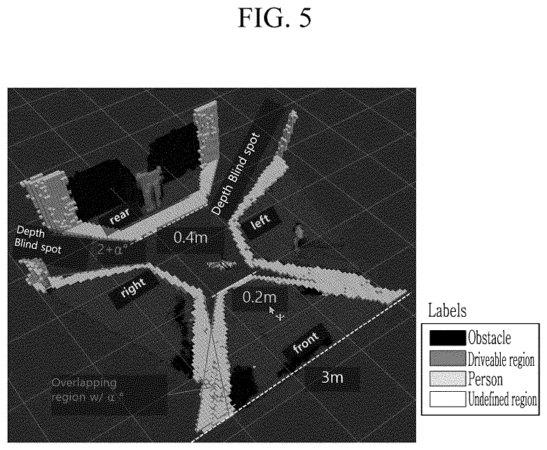

FIG. 5 is a drawing showing a semantic local map according to an exemplary embodiment of the present disclosure.

The semantic local map may display obstacles, driveable regions, persons and undesignated regions on the world coordinate system, to be distinguished from each other.

The semantic local map also utilizes depth, and therefore, can observe a wider region.

In FIG. 5, a region for persons and a region for obstacles may be regions to be avoided when the robot is driving. The depth outside the RGB FOV is undefined as RGB-based semantic segmentation is not possible, and the driveable region may be marked as shown.

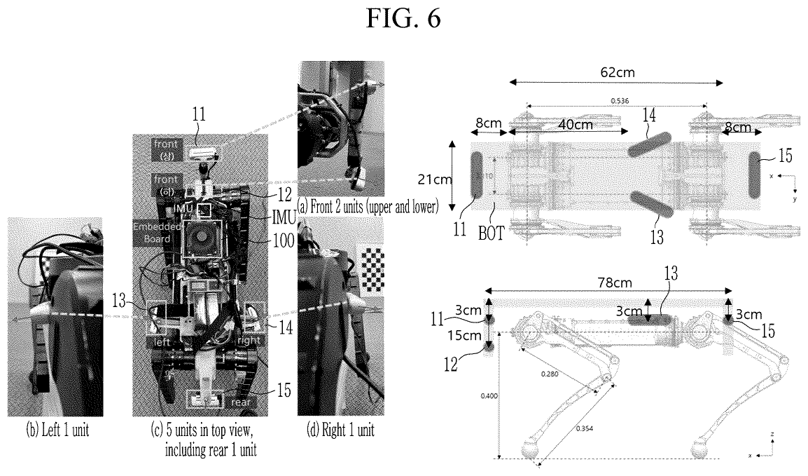

FIG. 6 is a drawing showing a robot according to an exemplary embodiment of the present disclosure. FIG. 6 shows an example of the multiple-sensor disposal system where a sensor whose horizontal field of view (FOV) is 89 degrees is used.

For example, FIG. 6 shows sensors mounted as payloads on a body of a quadruped robot.

The multi-sensor unit 10 (see FIG. 1) including the RGBD sensor and the IMU sensor is attached to the robot BOT. Furthermore, the data processing unit 100 (see FIG. 1) implemented in a form of an embedded board is attached to the robot BOT.

The RGBD sensor may be provided in a plural quantity. The plurality of RGBD sensors may include the first sensor 11, the second sensor 12, the third sensor 13, the fourth sensor 14, and the fifth sensor 15.

The first sensor 11 and the second sensor 12 may be disposed on a front surface of the robot BOT. The first sensor 11 and the second sensor 12 may be spaced apart with a predetermined distance in a z-axis direction. For example, the predetermined distance may be 15 cm.

The second sensor 12 may be attached closer to a ground surface than the first sensor 11, and may be tilted in a direction toward the ground surface. For example, the tilt angle may be 55 degrees.

The third sensor 13 and the fourth sensor 14 may be disposed on both side surfaces of the robot BOT, respectively.

The third sensor 13 and the fourth sensor 14 may be tilted in the direction toward the ground surface, and may be disposed rotated by a predetermined angle toward front surface. For example, the tilt angle may be 10 degrees, and the rotation angle may be 10 degrees.

The fifth sensor 15 may be disposed on a rear surface of the robot BOT.

The first sensor 11, the third sensor 13, the fourth sensor 14 and the fifth sensor 15 may be disposed at the same height from the ground surface.

The IMU sensor IMU and the data processing unit 100 may be disposed on a body of the robot BOT.

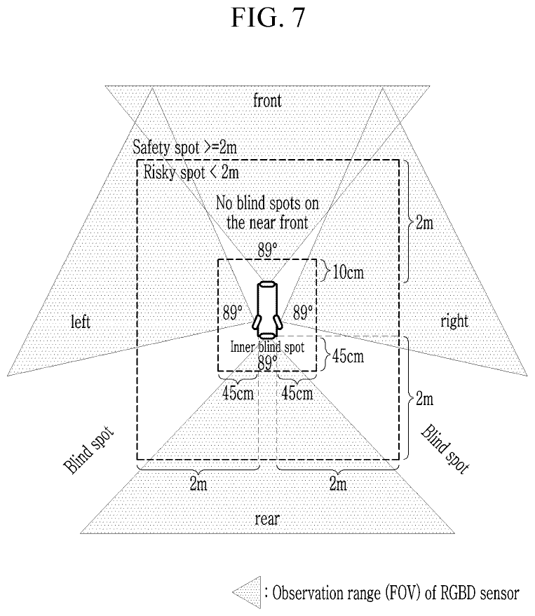

FIG. 7 is a drawing showing a field of view (FOV) of the multi-sensor unit according to an exemplary embodiment of the present disclosure.

FIG. 7 shows an example of a horizontal field of view through the multi-sensor unit 10 secured through the sensors of FIG. 6. The description will be made with reference to FIG. 6.

The arrangement of the multi-sensors may aim to minimally generate blind spots, based on the major driving direction (i.e., the forward direction) of the robot.

In FIG. 7, the second sensor 12 may be tilted downward so that a downward region in front of the robot may be observed (to reduce the minimum detection distance).

The third sensor 13 and the fourth sensor 14 may be rotated to face forward, to overlap with the field of view (FOV) of the first sensor 11 and the second sensor 12 by at least partially so that the entire forward range of 180 degrees may be detected.

The field of view (FOV) of the RGB data is smaller than the FOV of the depth data.

The semantic local map generation device 1000 (see FIG. 1) may extract a maximum FOV by combining the depth data of a region out of the FOV of the RGB data with the RGB data.

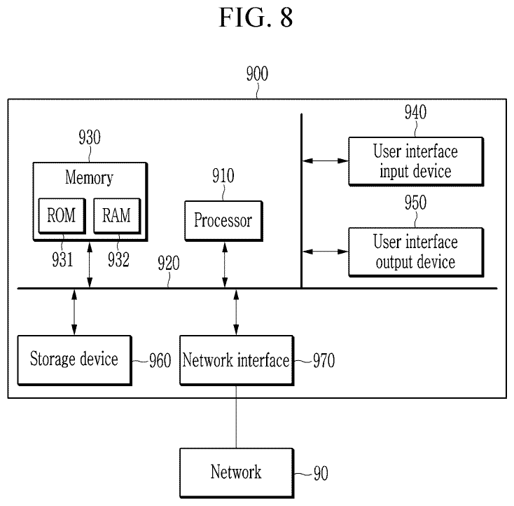

FIG. 8 is a drawing for explaining a computing device according to an exemplary embodiment of the present disclosure.

Referring to FIG. 8, a semantic local map generation device 1000 and method according to various exemplary embodiments of the present disclosure may be implemented by use of a computing device 900. In an exemplary embodiment of the present disclosure, the data processing unit 100 (see FIG. 1) connected to the sensors may be implemented by use of the computing device 900.

The computing device 900 may be attached to the robot in a form of an embedded board.

The computing device 900 may include at least one of a processor 910, a memory 930, the user interface input device 940, the user interface output device 950 and a storage device 960 that fluidically-communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device configured for executing instructions stored in the memory 930 or the storage device 960. The processor 910 may be configured to implement the functions and methods described above with respect to FIG. 1 to FIG. 7.

The memory 930 and the storage device 960 may include various types of volatile or non-volatile storage media. For example, the memory may include read-only memory (ROM) 931 and a random-access memory (RAM) 932. In the exemplary embodiment of the present disclosure, the memory 930 may be located inside or outside processor 910, and the memory 930 may be connected to the processor 910 through various known means.

In various exemplary embodiments of the present disclosure, at least some configurations or functions of the semantic local map generation device and method according to various exemplary embodiments of the present disclosure may be implemented as a program or software executable by the computing device 900, and program or software may be stored in a computer-readable medium.

In various exemplary embodiments of the present disclosure, at least some configurations or functions of the semantic local map generation device and method according to various exemplary embodiments of the present disclosure may be implemented by use of hardware or circuitry of the computing device 900, or may also be implemented as separate hardware or circuitry which may be electrically connected to the computing device 900.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A semantic local map generation device, comprising:
a multi-sensor unit including a RGBD sensor and an inertial measurement unit (IMU) sensor attached to a body of a robot; and
a data processing unit operatively connected to the multi-sensor unit and configured for estimating a pose of the robot and a semantic point cloud with respect to a driving region from sensor data obtained from the multi-sensor unit, and generate a semantic local map based on the estimated pose and the estimated semantic point cloud.

2. The semantic local map generation device of claim 1, wherein the multi-sensor unit is configured to obtain the sensor data including a stereo infrared (IR) image, IMU data, RGB data, and depth data.

3. The semantic local map generation device of claim 1, wherein the data processing unit is further configured to transfer information on driveable and undriveable regions to the robot in a form of a set of 3-dimensional coordinates by use of the generated semantic local map.

4. The semantic local map generation device of claim 2, wherein the data processing unit includes:
a pose estimator configured for estimating the pose of the robot based on the stereo infrared image and the IMU data;
a semantic cloud generator configured to generate the semantic point cloud based on the RGB data and the depth data; and
a semantic local map generator configured to generate the semantic local map based on the pose and the semantic point cloud.

5. The semantic local map generation device of claim 4, wherein the pose estimator is configured for estimating a position, a direction, and a speed of the robot by use of matching between visual feature points obtained from the continuous stereo infrared image and a pre-integration result of the IMU data.

6. The semantic local map generation device of claim 4, wherein the semantic cloud generator is configured to generate a semantic image through the RGB data, and generate the semantic point cloud of a 3-dimensional (3D) coordinate system reference from a 2-dimensional (2D) image coordinate system of a sensor origin by use of the depth data and an intrinsic parameter of a camera.

7. The semantic local map generation device of claim 4, wherein the semantic cloud generator is configured to determine a 2-dimensional semantic image from the RGB data, and determine a 3-dimensional semantic point cloud by combining the depth data and the 2-dimensional semantic image.

8. The semantic local map generation device of claim 5, wherein the semantic local map generator is configured to generate the semantic local map in a 3-dimensional world coordinate system by multiplying the pose and a 3-dimensional semantic point cloud.

9. The semantic local map generation device of claim 1,
wherein the RGBD sensor is provided in a plurality, and
wherein the plurality of RGBD sensors includes:
a first sensor and a second sensor attached to a front surface of the body of the robot to be spaced apart from each other with a predetermined distance in a direction perpendicular to a ground surface;
a third sensor and a fourth sensor attached to first and second side surfaces of the body, respectively; and
a fifth sensor attached to a rear surface of the body.

10. The semantic local map generation device of claim 9,
wherein the first sensor and the fifth sensor are in parallel to the ground surface,
wherein the second sensor is attached to be closer to the ground surface than the first sensor, and tilted in a direction toward the ground surface, and
wherein the third sensor and the fourth sensor are tilted in the direction toward the ground surface, and rotated toward the front surface.

11. A semantic local map generation method, comprising:
obtaining sensor data for generating a semantic local map through multi-sensors including an RGBD sensor and an inertial measurement unit (IMU) sensor mounted on a body of a robot; and
estimating a pose of the robot and a semantic point cloud from the sensor data, and generating the semantic local map in a 3-dimensional world coordinate system by use of the estimated pose and the estimated semantic point cloud.

12. The semantic local map generation method of claim 11, wherein the obtaining of the sensor data includes obtaining a stereo infrared image from a visual sensor, IMU data from the IMU sensor, RGB data from the RGBD sensor, and depth data from the RGBD sensor.

13. The semantic local map generation method of claim 11, wherein the generating of the semantic local map includes transferring information on a driveable region and an undriveable region to the robot in a form of a set of 3-dimensional coordinates by use of the generated semantic local map.

14. The semantic local map generation method of claim 12, wherein the generating of the semantic local map includes:
estimating the pose of the robot based on the stereo infrared image and the IMU data;
generating the semantic point cloud based on the RGB data and the depth data; and
determining the semantic local map based on the pose and the semantic point cloud.

15. The semantic local map generation method of claim 14, wherein the estimating of the pose of the robot includes estimating a position, a direction, and a speed of the robot by use of matching between visual feature points obtained from the continuous stereo infrared image and pre-integration result of the IMU data.

16. The semantic local map generation method of claim 14, wherein the generating of the semantic point cloud includes generating a semantic image through the RGB data, and generating the semantic point cloud of a 3-dimensional (3D) coordinate system reference from a 2-dimensional (2D) image coordinate system of a sensor origin by use of the depth data and an intrinsic parameter of a camera.

17. The semantic local map generation method of claim 14, wherein the generating of the semantic point cloud includes determining a 2-dimensional semantic image from the RGB data, and determining a 3-dimensional semantic point cloud by combining the depth data and the 2-dimensional semantic image.

18. The semantic local map generation method of claim 17, wherein the determining of the semantic local map includes generating the semantic local map in the 3-dimensional world coordinate system by multiplying the pose and the 3-dimensional semantic point cloud.

19. The semantic local map generation method of claim 12,
wherein a field of view (FOV) of the RGB data is smaller than a FOV of the depth data; and
wherein the generating of the semantic local map includes extracting a maximum FOV by combining depth data of a region outside the FOV of the RGB with the RGB data.

20. The semantic local map generation method of claim 11, wherein the semantic local map displays an obstacle, a driveable region, a person, and a undesignated region, in a manner to be distinguished from each other in the 3-dimensional world coordinate system.
